(19) United States
(12) Patent Application Publication
(10) Pub. No.: US 2025/0072700 A1
(43) Pub. Date: Mar. 6, 2025

(54) CLEANING APPARATUS

(71) Applicant: OHK DESIGN, LLC, AUSTIN, TX (US)

(72) Inventors: Omar Habib Khan, Pflugerville, TX (US); Dorian A. Ferrari, Colorado Springs, CO (US)

(73) Assignee: OHK DESIGN, LLC, AUSTIN, TX (US)

(21) Appl. No.: 18/824,769

(22) Filed: Sep. 4, 2024

Related U.S. Application Data
(60) Provisional application No. 63/536,463, filed on Sep. 4, 2023.

(51) Int. Cl. A47L 13/258; A47L 13/22; A47L 13/42; B25G 3/38

(52) U.S. Cl. CPC A47L 13/258; A47L 13/22; A47L 13/42; B25G 3/38

(57) ABSTRACT

In an embodiment, a cleaning apparatus is disclosed. The cleaning apparatus includes a handle, and a first and a second support member. Each of the first and the second support member may define a proximal end and a distal end, and may be coupled with the handle, via a connector. The connector may be rotatably coupled with the handle and configured to rotate relative to the handle. Each of first and the second support member may be rotatably coupled with the connector via respective proximal ends, and rotate about a respective axis. As a result, a distance between the distal ends of the first and the second support member is variable. The cleaning apparatus may further include a cleaning plate configured to be attached to each of first and the second support member, via the distal ends of the first and the second support member.

### CROSS-REFERENCE TO RELATED APPLICATIONS

The present application claims priority under 35 U.S.C. § 119(e) to U.S. Provisional Patent Application No. 63/536,463, titled CLEANING DEVICE, filed Sep. 4, 2023, the disclosure of which is herein incorporated by reference in its entirely.

### TECHNICAL FIELD

This disclosure relates generally to a cleaning apparatus, and in particular to a cleaning apparatus having a compact, hand-held cleaning apparatus that allows a cleaning plate multiple degrees of motion.

### BACKGROUND

Existing hand-held cleaning devices often suffer from limitations that hinder their effectiveness and versatility. One of the primary drawbacks is the use of rigid, fixed cleaning plates. These plates are unable to conform to the contours of surfaces, making it difficult to reach tight corners, crevices, or uneven areas. As a result, these devices may leave behind dirt or debris, leading to incomplete cleaning.

Furthermore, the fixed orientation of the cleaning plate limits the device's adaptability to different cleaning tasks and surfaces. For example, when cleaning delicate fabrics or sensitive electronics, it is crucial to use a gentle approach that avoids excessive pressure or friction. A rigid cleaning plate may not be able to provide the necessary control and flexibility in these situations.

In addition to these limitations, conventional cleaning devices often have complex designs and require multiple components. This can make them more expensive to manufacture and repair. Moreover, the intricate assembly process can increase the likelihood of defects or malfunctions.

These combined challenges highlight the need for a more versatile and efficient hand-held cleaning device that can overcome the limitations of existing models.

### SUMMARY

In an embodiment, a cleaning apparatus is disclosed. The cleaning apparatus may include a handle defining a top end and a bottom end, and a first and a second support member. Each of the first and the second support member may define a proximal end and a distal end, and each of the first and the second support member may be coupled with the handle near the top end of the handle, via a connector. The connector may be rotatably coupled with the handle and configured to rotate relative to the handle about a horizontal axis. Each of first and the second support member may be rotatably coupled with the connector via the respective proximal end, and may be configured to rotate about a respective vertical axis perpendicular to the horizontal axis, as a result of which, a distance between the distal ends of the first and the second support member is variable. The cleaning apparatus may further include a cleaning plate configured to be attached to each of first and the second support member, via the distal ends of the first and the second support member

In an embodiment, each of the first and the second support members may include a plurality of gear teeth, such that the plurality of gear teeth of the first support member are meshed with the plurality of gear teeth of the second support member. As a result, rotation of one of the first and second support member causes an equal and opposite rotation of the other of the first and second support member.

In an embodiment, the cleaning apparatus may further include a locking mechanism for locking the rotation of the connector relative to the handle about the horizontal axis. The locking mechanism may include one of a female locking structure and a male locking structure associated with the connector. The other of the female locking structure and the male locking structure may be associated with the handle. The connector may be configured to move linearly towards the handle to engage the female locking structure and male locking structure, to thereby lock the rotation of the connector relative to the handle. Further, the connector is configured to move linearly away from the handle to disengage the female locking structure and male locking structure, to thereby unlock and enable the rotation of the connector relative to the handle. The locking mechanism may further include a first biasing member attached to the connector and positioned between the female locking structure and the male locking structure, to bias the connector towards the handle to thereby keep the female locking structure and the male locking structure engaged with each other and thereby lock the rotation of the connector relative to the handle. The connector may move linearly away from the handle upon overcoming a biasing force of the first biasing member.

In an embodiment, the cleaning apparatus may further include a second biasing member engaged with one of the first and the second support members on one end thereof and with the connector on the other end thereof. The second biasing member biases the first and the second support members in one of a closed configuration and open configuration. In the closed configuration, the distance between the distal ends of the first and the second support members is a minimum possible distance. In the open configuration, the distance between the distal ends of the first and the second support members is a maximum possible distance.

In an embodiment, the first and the second support members may include a first support stopper and a second support stopper, respectively, on inner side thereof. Each of the first and the second support stopper may have a sliding profile. The cleaning apparatus may further include a support limiter configured to slidably engage with the first and the second support stopper. When engaged with both the first and the second support stopper, the support limiter may lock the first and the second support members in the closed configuration. In an embodiment, one of the first and second support stoppers may have a longer length than the other of the first and second support stoppers. The support limiter may be permanently engaged with the longer of the first and second support stoppers. The support limiter may engage with the shorter of the first and second support stoppers, when the first and second support members are in the closed configuration. The support limiter may be engaged with both the first and second support stoppers, by sliding the support limiter over an overlapped length between the first and second support stoppers. Further, in some embodiments, the longer of the first and second support stoppers may comprise end-barriers to arrest the falling-off of the support limiter.

In an embodiment, the cleaning plate may possess out-of-plane flexibility enabling the cleaning plate to be configured in a convex curvature and a concave curvature. The cleaning plate is configured in the concave curvature when the distance between the distal ends of the first and the second support members is more than a minimum predefined distance. Further, the cleaning plate is configured in the convex curvature when the distance between the distal ends of the first and the second support members is less than the minimum predefined distance.

In an embodiment, the cleaning plate may include a plurality of left tracks and a plurality of right tracks positioned along a longitudinal length of the cleaning plate and on a rear side of the cleaning plate. The first support member may include a first carriage rotatably coupled to the distal end of the first support member, and the second support member may include a second carriage rotatably coupled to the distal end of the second support member. The cleaning plate may be configured to be attached to the first and second support members by engaging one of the plurality of left tracks with the first carriage and engaging one of the plurality of right tracks with the second carriage. A length of each of the plurality of left tracks and a plurality of right tracks may be greater than length of the first carriage and the second carriage.

In an embodiment, the cleaning plate may further include a proximal carriage barrier positioned in the middle of the longitudinal length of cleaning plate. The proximal carriage barrier may provide a stopping point for the first carriage and the second carriage, when the first and the second support members are in the closed configuration.

In an embodiment, the cleaning plate may further include a left distal carriage barrier positioned towards the left extreme end of the longitudinal length of cleaning plate, and a right distal carriage barrier positioned towards the right extreme end of the longitudinal length of cleaning plate. The left distal carriage barrier and the right distal carriage barrier may be configured to provide a stopping point for the first carriage and the second carriage, respectively, when the first and the second support members are in the open configuration.

In an embodiment, the handle may include a housing for receiving a cartridge containing a cleaning solution. The cartridge may be configured to be operated for sparing a dosage of cleaning solution for assisting in cleaning action to be performed using the cleaning plate. The handle may comprise a top module and a bottom module, such that the top module is detachably attached to the bottom module. The bottom module may define the housing for receiving the cartridge, and the top module may be coupled to the cleaning plate.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a front perspective view of the cleaning apparatus, in accordance with some embodiments of the present disclosure.

FIG. 2 illustrates a rear perspective view of the cleaning apparatus of FIG. 1, in accordance with some embodiments of the present disclosure.

FIG. 3 illustrates a right-side view of the cleaning apparatus of FIG. 1, in accordance with some embodiments of the present disclosure.

FIG. 4 illustrates a rear view of the cleaning apparatus of FIG. 1, in accordance with some embodiments of the present disclosure.

FIG. 5 illustrates a top view of the cleaning apparatus of FIG. 1, in accordance with some embodiments of the present disclosure.

FIG. 6 illustrates a front view of the cleaning apparatus of FIG. 1, in accordance with some embodiments of the present disclosure.

FIG. 7 illustrates an exploded view of the cleaning apparatus of FIG. 1, in accordance with some embodiments of the present disclosure.

FIG. 8 illustrates an exploded view of an alternate embodiment of the cleaning apparatus with some modifications.

FIGS. 9-11 illustrate schematic top views of a part of the cleaning apparatus showing the first and the second support members, the first and the second support stoppers, and the support limiter, in different configurations of first and the second support members, in accordance with some embodiments.

FIG. 12 illustrates an exploded view of an assembly of the first and the second support members, the first and the second support stoppers, and the support limiter, in accordance with some embodiments.

FIG. 13 illustrates a left-side view of a cleaning plate.

FIG. 14 illustrates a top view of the cleaning plate of FIG. 13.

FIG. 15 illustrates a rear view of the cleaning plate of FIG. 13.

FIG. 16 illustrates a front view of the cleaning plate of FIG. 13.

FIG. 17 illustrates a cross-sectional right-side view of the cleaning plate of FIG. 13.

FIGS. 18-19 illustrate a perspective view and a side view, respectively, of a carriage.

FIG. 20 illustrates a perspective view of a carriage.

FIG. 21 illustrates a perspective view of the carriage engaged with a support member 2102.

FIG. 22 illustrates a schematic top view of a part of the cleaning apparatus showing the first and second support members, the first and second carriages, and the cleaning plate configured in concave curvature.

FIG. 23 illustrates a schematic top view of a part of the cleaning apparatus showing the first and second support members, the first and second carriages, and the cleaning plate configured in convex curvature.

FIG. 24 illustrates another exploded view of the cleaning apparatus of FIG. 8 showing cleaning plate, gripping surface, and cleaning surface.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

### Overview

To address the challenges associated with cleaning apparatuses, the present subject provides for a cleaning apparatus having a small form-factor, i.e. having small physical size and or shape. Further, the cleaning apparatus incorporates a cleaning plate that is moveable, flexible, and comprised of simple components. The flexible cleaning plate is moveably associated with a handle of the cleaning apparatus.

The handle of the cleaning apparatus may include a housing for storage of a container. The housing may store a container such as a fluid dispenser in form of a spray bottle. The container may contain a cleaning solution that can be sprayed on the surface during the cleaning process. The housing may include a door that may be adapted to receive the container. In one embodiment, the door may be pivotable about the housing of the handle, and as such, may be configured to open or close by way of rotating about a pivot point near a bottom end of the handle. The opening and closing of the door allows for accessing the container placed within the housing, for example, for replacing the container.

The cleaning plate of the cleaning apparatus may be rotatable relative to the handle. To this end, the cleaning plate may be coupled to the handle via a connector. The connector may be rotatable relative to the handle and hence may be configurable between a locked position and an unlocked position with respect to the handle. When in the unlocked position, the connector allows for the in-plane rotational movement of the cleaning plate. The connector (and hence the cleaning plate) can be manually moved from a default locked position to an unlocked position, and then manually rotated to actuate the in-plane rotation of the cleaning plate. In other words, the connector may be manually moved from the locked position to the unlocked position by moving the connector linearly away from the handle and then rotated. Releasing the connector may lead to the connector moving back to its default locked position.

The cleaning plate may have a an out-of-plane flexure, and an in-plane rotational movement. Further, the out-of-plane flexure of the cleaning plate may be in a first direction, resulting in a concave curvature at a cleaning side of the cleaning plate, or in a second direction, resulting in a convex curvature at a cleaning side of the cleaning plate.

The cleaning plate may be connected to the handle via a first support member and a second support member. The first support and the second support members can be manually moved closer to each other (closed configuration) or farther apart from each other (open configuration). For example, the default position for the first and second support members may be the open configuration. Once configured in the closed configuration, the first support and second support members may be manually interlocked in this position using a locking mechanism. Further, in the closed configuration, the out-of-plane flexure of the cleaning plate may be configured in the convex curvature at the cleaning side of the cleaning plate. Therefore, the cleaning plate has both an out-of-plane flexure, and an in-plane rotational movement when the first and the second support members are configured in closed configuration.

The rotation process of the cleaning plate via the connector when the first and the second support members are in closed configuration is same as when the first and the second support members are configured in open configuration. Further, the rotation of the cleaning plate may take place in either clockwise or counterclockwise direction.

Each of the first and the second support members may define a distal end that may be moveably associated with the cleaning plate, and a proximal end that may be moveably associated with the handle. Further, the proximal ends of the first and second support members may be moveably associated with each other, so that they move substantially together. To this end, the proximal ends of the first and the second support members may include gear teeth that are enmeshed with each other. As such, a movement of one of the first and the second support members translates into a corresponding movement of the other of the first and the second support members, by an equal amount and in opposite direction.

Once the first and the second support members are configured in the closed configuration, it may be desirable to hold that position, for example, when the cleaning plate is to be used in a convex curvature. To this end, the first and the second support members may include first and second support stoppers and a support limiter. The first support stopper and the second support stopper may be defined on an inner side and along a length of the first and the second support members, respectively. Further, the length of one of the first support stopper and second support stopper may be longer than the other. The support stoppers may have a sliding profile along their length. A support limiter may be configured to slidably engage with the first support stopper and second support stopper. When the support limiter is engaged with both the first and the second support stoppers, the support limiter may lock the first and the second support members in the closed configuration. The support limiter may be permanently engaged with one of the first and second support stoppers having the longer length. The support limiter may be engaged with the other of the first and the second support stoppers, when the first and the second support members are in the closed configuration, by sliding the support limiter over an overlapped length between the first and the second support stoppers. The locking of the first and second support members in the closed configuration using the support stoppers and support limiter allows the first and second support members to assume a perpendicular orientation in relation to the plane of the cleaning plate.

The connector may include a housing that may secure a first end and a portion of the body of the biasing member. Further, a second end and a second portion of body of the biasing member may be secured within a recess located at a proximal end side of the first support member 104.

The attachment side (i.e. rear side) of the cleaning plate may include a plurality of tracks that may be comprised of a plurality of left tracks and a plurality of right tracks that may be generally aligned along a center longitudinal axis of the cleaning plate. As such, the plurality of left and right tracks may include discrete tracks, oriented longitudinally parallel to the longitudinal axis of the cleaning plate. A track-spacing between each discrete track may allow for the flexure of the cleaning plate. It should be noted that the size of the track-spacing between each pair of tracks may be smaller than a length of the first and second carriages, to thereby enable the first and second carriages to slide from one track to track. Further, the length of the tracks may be longer than the length of the first and second carriages, to allow a smoother motion thereof from one track to the next.

The first and the second support members may include a first carriage and a second carriage, respectively, rotatably coupled to the distal ends of the first and the second support members. The cleaning plate may be attached to the first and second support members by engaging one of the plurality of left tracks with the first carriage and engaging one of the plurality of right tracks with the second carriage. The coupling of the distal ends of the first and the second support member with the respective carriage may be accomplished by any well-known coupling techniques, including but not limited to, a fastener/nut combination, snap-fit assembly, interference (friction or press) fit assembly, etc. The carriages may each include a connecting end that moveably links the carriage to respective proximal end of the first and second support members. The carriages may further include a channel (i.e. track-engagement mechanism) that enables the carriage to slide along a track of the cleaning plate.

The cleaning plate may include distal carriage barriers that provide a stopping point for the first carriage and the second carriage at lateral distal ends of the tracks, when the first and second support members are positioned in open configuration. The track may have a width that is shorter than a length of the distal carriage barrier, and a length that is longer than space between tracks. A proximal carriage barrier may be mounted onto a general middle section of the cleaning plate, and the set of distal carriage barriers may be an integral part of the track located at extreme ends of the cleaning plate. The proximal carriage barrier may include a single, integral unitary piece having a barrier portion and barrier connectors. The proximal carriage barrier may be positioned in between the left and right tracks, and may have a size sufficient to allow appropriate spacing between the first and the second support members in the closed configuration. The spacing or gap prevents contact between the first and second support members when in the closed configuration, which allows the first and second support members to be aligned perpendicular to the plane of the cleaning plate. The proximal carriage barrier may include ports for fastening the proximal carriage barrier to the engagement side of the cleaning plate.

The cleaning plate is configured to allow mounting of a cleaning cloth thereto, for cleaning various surfaces. The cleaning cloth may include a disposable or microfiber bonnet type cleaning cloth. The cleaning cloth may be detachably attached to a cleaning (front) side of the cleaning plate by a variety of connection mechanism, including VELCRO®. Further, the attachment side (i.e. rear side) of the cleaning plate may include a holding mechanism, such as hooks to allow for attachment of cleaning cloth. Furthermore, a cleaning cloth grip mechanism, such as a gripping surface may be fixed (e.g. bonded by an adhesive material) to the cleaning side (front side) of the cleaning plate. The gripping surface (also referred to as rubber grip or rubberized texture) may be bonded to the cleaning side (i.e. front side) of the cleaning plate to increase friction between the cleaning plate and a cleaning cloth, thereby allowing for a rigorous scrubbing and achieving better cleaning results.

### Exemplary System

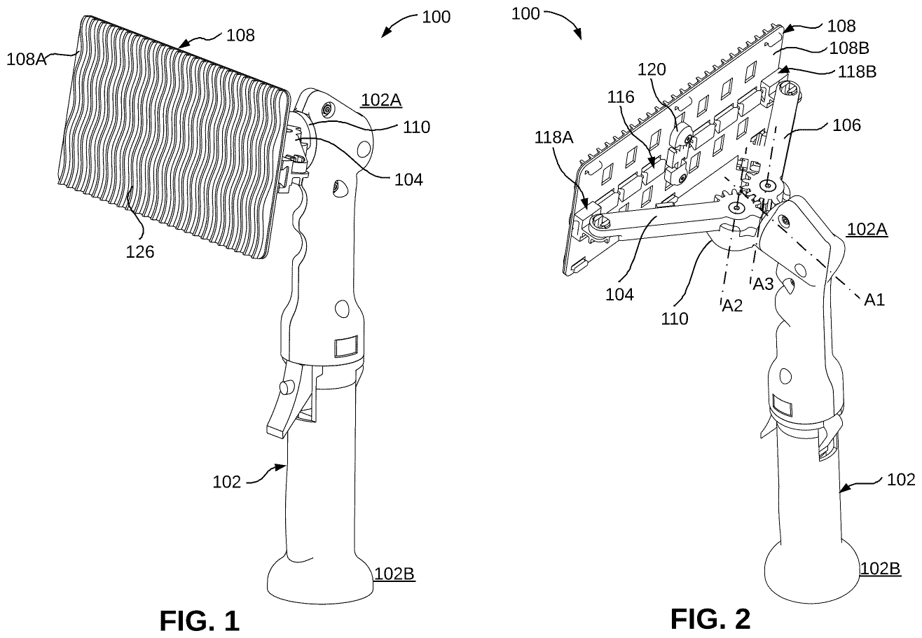

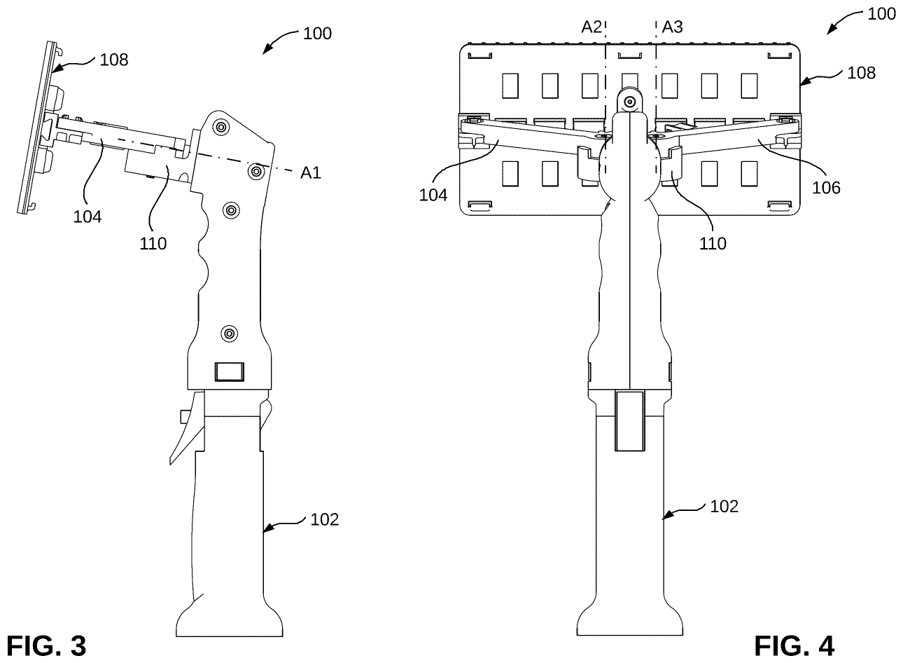

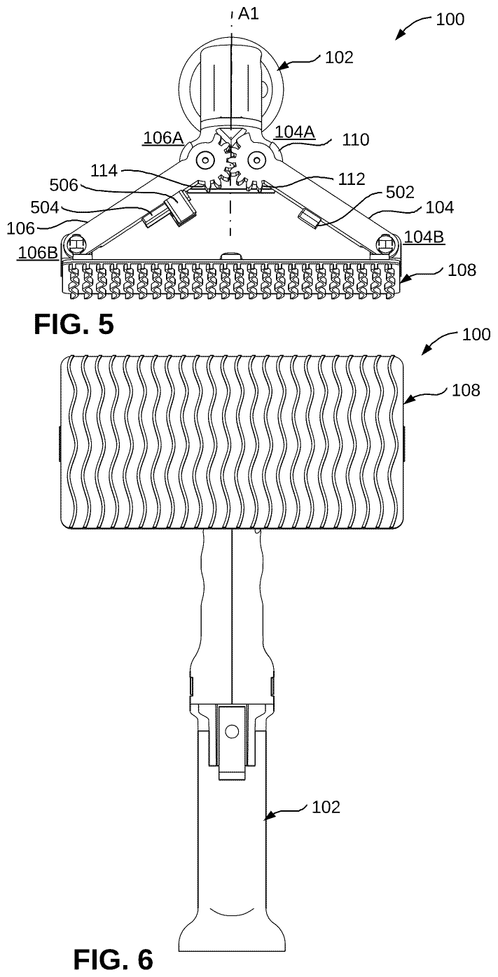

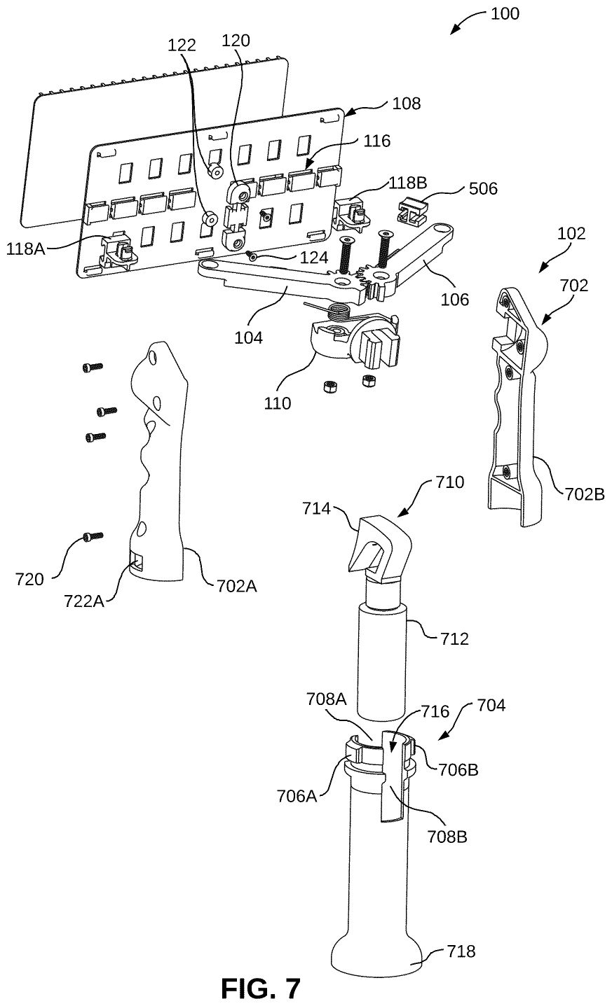

Referring now to FIGS. 1-7, various views of a cleaning apparatus 100 are illustrated, FIG. 1 illustrates a front perspective view of the cleaning apparatus 100; FIG. 2 illustrates a rear perspective view of the cleaning apparatus 100; FIG. 3 illustrates a right-side view of the cleaning apparatus 100; FIG. 4 illustrates a rear view of the cleaning apparatus 100; FIG. 5 illustrates a top view of the cleaning apparatus 100; FIG. 6 illustrates a front view of the cleaning apparatus 100; and FIG. 7 illustrates an exploded view of the cleaning apparatus 100, in accordance with an embodiment of the present invention. It should be noted that the cleaning apparatus 100, as shown in FIGS. 1-7 is configured in an open configuration of first and second support members.

As illustrated in FIGS. 1-7, the cleaning apparatus 100 may include a handle 102. The handle 102 may be used to hold the cleaning apparatus 100, using one or both hands of a user. The handle 102 may house a container that contains a cleaning solution (liquid) that will be explained in subsequent sections of the disclosure. Further, the handle 102 may include two sections—an upper and a lower section that also is explained subsequent sections of the disclosure. A body of the handle 102 may be manufactured from a rigid material, such as a metal, an alloy, a plastic, or a composite material. As shown in FIGS. 1-2, the handle may define a top end 102A and a bottom end 102B

The cleaning apparatus 100 may further include a first support member 104 and a second support member 106. Further, the cleaning apparatus 100 may include a cleaning plate 108. The cleaning plate 108 may be coupled to the handle 102 via the first and second support members 104, 106. Each of the first and second support members 104, 106 may define a proximal end and a distal end. As shown in FIG. 5, the first support member 104 may define a proximal end 104A and a distal end 104B, and the second support member 106 may define a proximal end 106A and a distal end 106B. Each of the first and second support members 104, 106 may be, as such, elongated members having a circular, squarish, or a rectangular cross-section. Further, each of the first and second support members 104, 106 may have a hollow or a solid cross-sectional construction. Furthermore, each of the first and second support members 104, 106 may be manufactured from a rigid material, such as a metal, an alloy, a plastic, or a composite material.

Each of the first and second support members 104, 106 may be coupled with the handle 102 near the top end 102A of the handle 102, via a connector 110. The connector 110 may be rotatably coupled to the handle 102 and may be configured to rotate or adjustable relative to the handle 102 about a horizontal axis A1, as shown in FIGS. 2, 3, and 5. Each of the first and second support members 104, 106 may be rotatably coupled with the connector 110 via the respective proximal end. As such, the first support member 104 may be rotatably or adjustably coupled with the connector 110 via the proximal end 104A, and the second support member 106 may be rotatably or adjustably coupled with the connector 110 via the proximal end 106A.

Each of the first and second support members 104, 106 may be configured to rotate or adjust about a respective vertical axis perpendicular to the horizontal axis A1, as a result of which, a distance between the distal ends 104B, 106B of the first and the second support member 104, 106 may be varied. In particular, the first support member 104 may be configured to rotate about a vertical axis A2 which is perpendicular to the horizontal axis A1; and the second support member 106 may be configured to rotate about a vertical axis A3 which is also perpendicular to the horizontal axis A1.

As a result of the rotation of the first support member 104 and the second support member 106 about the respective vertical axes A2, A3, a distance between the distal ends 104B, 106B of the first and second support members 104, 106 may be varied. In other words, the first and second support members 104, 106 may be configurable in one of a closed configuration and an open configuration. In the open configuration, as illustrated in FIGS. 1-7, the first and second support members 104, 106 are spaced apart, and a distance between the distal ends 104B, 106B of the first and second support members 104, 106 is a maximum possible distance. In the closed configuration, the first and second support members 104, 106 are positioned closer each other, as shown in FIG. 11, and the distance between the distal ends 104B, 106B of the first and second support members 104, 106 is a minimum possible distance. The closed configuration of the first and second support members 104, 106, as shown in FIG. 11, may allow the first and second support members 104, 106 to assume a perpendicular orientation in relation to the plane of the cleaning plate 108.

It should be noted that a plurality of intermediate configurations may be possible between the closed and the open configuration. As such, it may be possible to increase or decrease the distance between first and second support members 104, 106 by a plurality of finite gradations.

In some embodiments, as shown in FIGS. 2, 5, 9-11, each of first and second support members 104, 106 may include a plurality of gear teeth 112, 114, respectively. As shown in FIGS. 2, 5, plurality of gear teeth 112, 114 may be defined on a circular segment around the vertical axes A2, A3. Further, the plurality of gear teeth 112 of the first support member 104 may be meshed with the plurality of gear teeth 114 of the second support member 106. As a result of the meshing, rotation of one of the first and second support members 104, 106 may cause an equal and opposite rotation of the other of the first and second support members 104, 106. For example, if the first support member 104 is rotated manually about the axis A2, the meshing of the gear teeth may cause the second support member 106 to rotate in the opposite direction and by equal amount of rotation. As such, the meshing of the gear teeth enables a symmetrical movement of the first and second support members 104, 106.

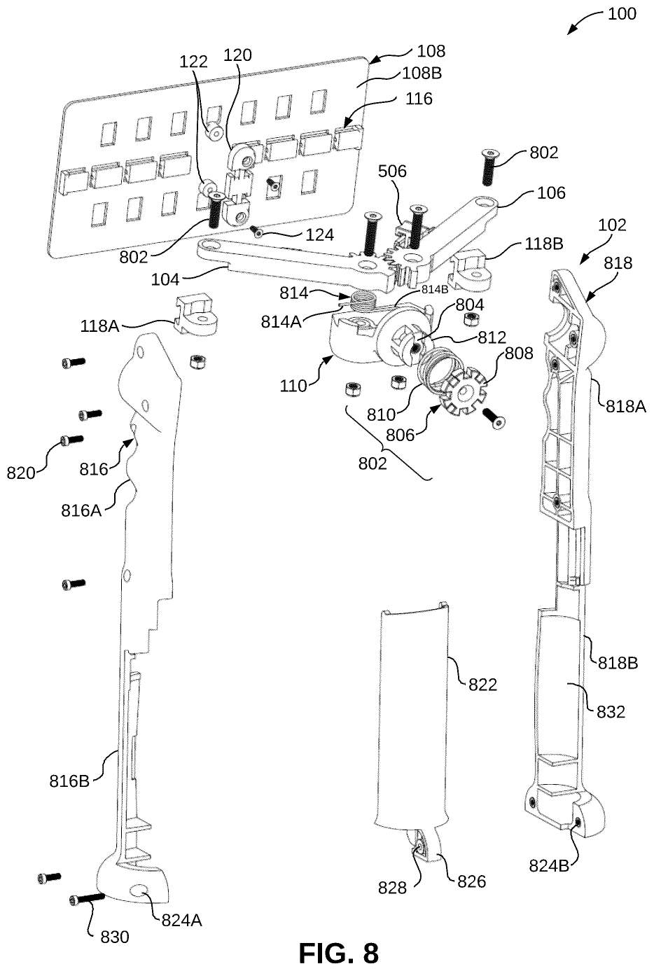

In some embodiments, the cleaning apparatus 100 may further include a locking mechanism 802 for locking the rotation of the connector 110 relative to the handle 102 about the horizontal axis A1. The locking mechanism 802 may include one of a female locking structure and a male locking structure associated with the connector 110, and the other of the female locking structure and the male locking structure associated with the handle 102. In one particular embodiment, as shown in FIG. 8, a female locking structure 804 may be associated with the connector 110, and a male locking structure 808 may be associated with the handle 102. In particular, the connector 110 may include the female locking structure 804 formed on a rear side 812 of the connector 110. The female locking structure 804 may be in form of a depression formed on the rear side 812 of the connector 110. Further, the locking mechanism 802 may include a wheel 806 that may be fixed to the handle 102. As shown in FIG. 8, the wheel 806 may be housed within a housing associated with the top end 102A of the handle 102. The wheel 806 may be manufactured as a separate component and fixed to the handle 102, or the wheel 806 may be formed within the handle 102.

The wheel 806 may define a plurality of male locking structures 808 throughout its periphery. The shape of the male locking structures 808 may match with the shape of the female locking structure 804, so as to allow a pair of opposite male locking structures 808 to engage with the (depression of) female locking structure 804 of the connector 110. Once the female locking structure 804 of the connector 110 is engaged with the pair of male locking structures 808, owing to the fixed position of the wheel 806, the rotation of the connector 110 is prevented. Thus, to rotate the connector 110, the female locking structure 804 of the connector 110 must be first disengaged from the corresponding male locking structures 808. To this end, the connector 110 may be moved linearly away from the handle 102 to disengage the female locking structure 804 from male locking structure 808, to thereby unlock and enable the rotation of the connector 110 relative to the handle 102. Once disengaged, the connector 110 may be rotated by a desired amount, and then female locking structure 804 may be engaged with a different pair of male locking structures 808, to fix the position of the connector 110. To this end, the connector 110 may be moved linearly back towards the handle 102 to engage the female locking structure 804 with the male locking structures 808, to thereby lock the rotation of the connector 110 relative to the handle 102.

In some embodiments, as shown in FIG. 8, the locking mechanism 802 may further include a first biasing member 810 attached to the connector 110 and positioned between the female locking structure 804 and the male locking structure 808 (i.e. the wheel 806). The first biasing member 810 may bias the connector 110 towards the handle 102 to thereby keep the female locking structure 804 and the male locking structures 808 engaged with each other and thereby lock the rotation of the connector 110 relative to the handle 102.

In order to rotate the connector 110, the user may move the connector 110 linearly away (i.e. pulled) from the handle 102 upon overcoming a biasing force of the first biasing member 810, until the female locking structure 804 is disengaged from the male locking structures 808. For example, when the connector 110 is pulled, the first biasing member 810 may be compressed against an engagement side of the connector 110 and the male locking structures 808. Thereafter, while holding the connector 110 linearly away from the handle 102, the connector 110 may be rotated to the desired amount. Thereafter, the connector 110 may be released to thereby cause the first biasing member 810 to once again engage the female locking structure 804 with the male locking structures 808. The first biasing member 810, for example, may include a helical spring (as shown in FIG. 8), a spiral spring, etc. manufactured from a spring-grade material, such as Spring Steel.

In some embodiments, the cleaning apparatus 100 may further include a second biasing member 814 that may be engaged with one of the first and second support members 104, 106 on one end thereof and with the connector 110 on another end thereof. The second biasing member 814 may bias the first and second support members 104, 106 in one of a closed configuration and open configuration. As shown in FIG. 8, a first end 814A of the second biasing member 814 may be secured within a recess (not visible in FIG. 8) located at the proximal end of the first support member 104. Further, the connector 110 may define a housing that may secure a second end 814B of the second biasing member 814. As such, the second biasing member 814 may be engaged with, i.e. contact the first support member 104 on one end thereof and with the connector 110 on another end thereof. In this configuration as shown in FIG. 8, the second biasing member 814 may bias the first support member 104 (and hence the second support member 106) in the open configuration. As such, by default, the second biasing member 814 may cause to configure the first and second support members 104, 106 in the open configuration. Hence, in order to configure the first and second support members 104, 106 in the closed configuration, the user may have to apply effort to overcome a biasing force of the second biasing member 814 to thereby move the first and second support members 104, 106 closer to each other. As mentioned above, in the closed configuration, the distance between the distal ends 104B, 106B of the first and second support members 104, 106 is a minimum possible distance. In the open configuration, the distance between the distal ends 104B, 106B of the first and second support members 104, 106 is a maximum possible distance.

Once the first and second support members 104, 106 are configured in in the closed configuration, it may be desirable to hold that position, for example, when the cleaning plate 108 is to be used in a convex curvature. To this end, the first and second support members 104, 106 may include first and second support stoppers and a support limiter. This is explained in conjunction with FIGS. 5 and 9-12.

As shown in FIG. 5, the first support member 104 may include a first support stopper 502, and the second support member 106 may include a second support stopper 504. The first support stopper 502 and second support stopper 504 may be defined one an inner side and along a length of the first support member 104 and the second support member 106, respectively. It should be noted that length of one of the first support stopper 502 and second support stopper 504 may be longer than the other. For example, as shown in FIG. 5, length of the second support stopper 504 is greater than that of the first support stopper 502. Each of the first support stopper 502 and the second support stopper 504 may have a sliding profile; in other words, each of the first and the second support stopper may define a rail-like cross-section along its length.

Further, as shown in FIG. 5, 7, 8, the cleaning apparatus 100 may include a support limiter 506 that may be configured to slidably engage with the first support stopper 502 and second support stopper 504. When the support limiter 506 is engaged with both the first and second support stoppers 502, 504, the support limiter 506 may lock the first and second support members 104, 106 in the closed configuration. The support limiter 506 may be permanently engaged with one of the first and second support stoppers 502, 504 having the longer length. The support limiter 506 may be engaged with the other of the first and second support stoppers 502, 504, when the first and second support members 104, 106 are in the closed configuration, by sliding the support limiter 506 over an overlapped length between the first and second support stoppers 502, 504. For example, as shown in FIG. 5, the support limiter 506 may be permanently engaged with the second support stopper 504 having the longer length. The support limiter 506 may be engaged with the other of the first and second support stoppers 502, 504 when the first and second support members 104, 106 are in the closed configuration, by sliding the support limiter 506 over an overlapped length between the first and second support stoppers 502, 504.

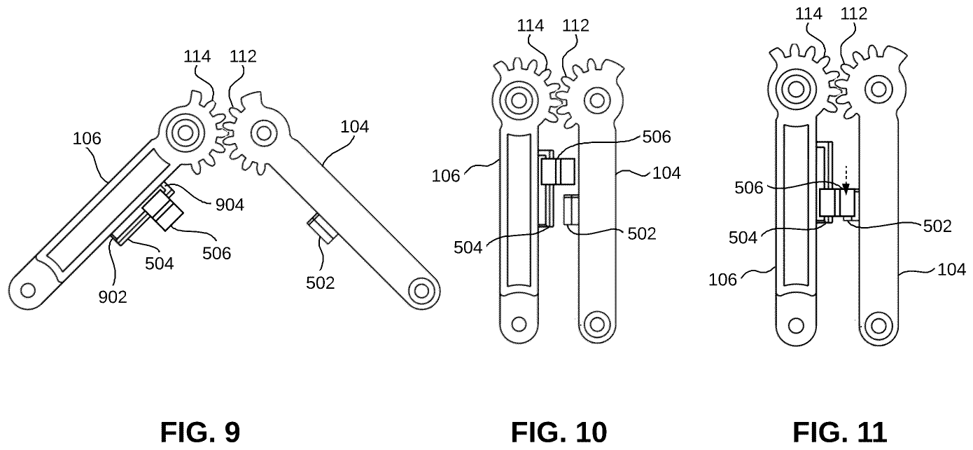

Referring now to FIGS. 9-11, schematic top views of a part of the cleaning apparatus 100 showing the first and second support members 104, 106, the first and second support stoppers 502, 504, and the support limiter 506 are illustrated, in accordance with some embodiments. As shown in FIG. 9, the first and second support members 104, 106 are configured in the open configuration, and as such, the first and second support members 104, 106 are positioned farther away from each other. Further, in this configuration, the support limiter 506 is engaged only with the second support stopper 504 with which it is permanently engaged. The support limiter 506 may be configured to slide over the entire length of the second support stopper 504. In order to configure the first and second support members 104, 106 in the closed configuration, the first and second support members 104, 106 may be manually manipulated to be positioned closer to each other.

As shown in FIG. 10, the first and second support members 104, 106 are configured in the closed configuration, and therefore, positioned proximal to each other. In order to lock the first and second support members 104, 106 in the closed configuration, the support limiter 506 may be slid (along the direction of the arrow) over an overlapped length between the first and second support stoppers 502, 504, as shown in FIG. 11.

As shown in FIG. 11, once the support limiter 506 is slid over the overlapped length between the first and second support stoppers 502, 504, the support limiter 506 may be engaged with both the first and second support stoppers 502, 504. As a result, the support limiter 506 locks the first and the second support members 502, 504 in the closed configuration. Further, as will be understood, in order to release the closed configuration, the support limiter 506 may be slid in the opposite direction until the support limiter 506 fully releases the first support stopper 502. Once released from the closed configuration, the first and second support members 104, 106 may automatically move farther apart from each other under the effect of the second biasing member 814, to thereby configure the first and second support members 104, 106 in the open configuration.

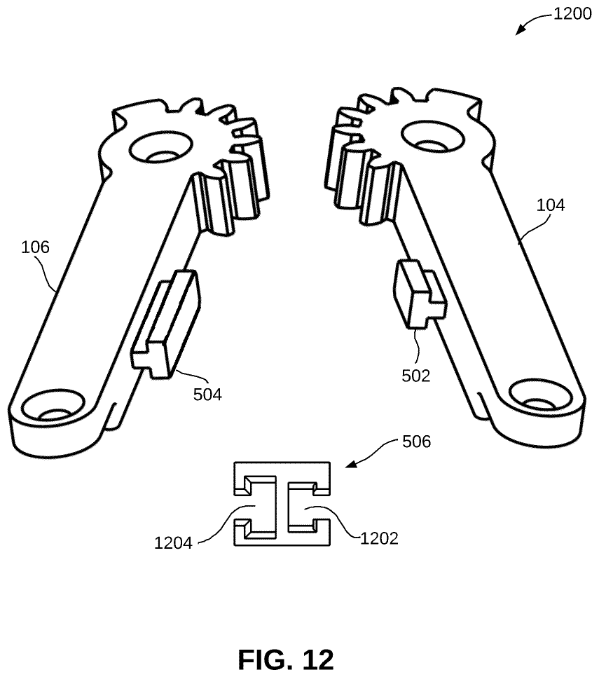

In some embodiments, one of the first and second support stoppers 502, 504 having the longer length may include end-barriers to arrest the falling-off of the support limiter 506. As shown in FIG. 9, the second support stopper 504 having the longer length may include end-barriers 902, 904 defined at extreme ends of the length of the second support stopper 504. For example, the end-barriers 902, 904 may include a protrusion that may curtail the movement of the support limiter 506 beyond the end-barriers 902, 904. As such, the support limiter 506 is free to slide along the length of the second support stopper 504, but trapped between the end-barriers 902, 904. The first and second support stoppers 502, 504 and the support limiter 506 is further explained in conjunction with FIG. 12.

FIG. 12 is an exploded view 1200 of an assembly of the first and second support members 104, 106, the first and second support stoppers 502, 504, and the support limiter 506, in accordance with some embodiments. As mentioned above, the first support member 104 may include the first support stopper 502, and the second support member 106 may include the second support stopper 504. The first support stopper 502 and second support stopper 504 may be defined one an inner side and along a length of the first support member 104 and the second support member 106, respectively. The length of second support stopper 504 may be greater than the length of first support stopper 502. Further, as shown in FIG. 12, each of the first support stopper 502 and the second support stopper 504 may have a sliding profile, i.e. each of the first and second support stoppers 502, 504 may define a rail-like cross-section along its respective length.

The support limiter 506 may be configured to slidably engage with the first support stopper 502 and second support stopper 504. As shown in FIG. 12, the support limiter 506 may define a first channel 1202 and a second channel 1204. The first channel 1202 may be configured to engage with the sliding profile of the first support stopper 502. Further, the second channel 1204 may be configured to engage with the sliding profile of the second support stopper 504. In other words, the support limiter 506 may slide on the first support stopper 502 via the first channel 1202, and on the second support stopper 504 via the second channel 1204.

The support limiter 506 may be permanently engaged with the second support stopper 504. Further, the support limiter 506 may be engaged with the first support stopper 502, when the first and second support members 104, 106 are in the closed configuration, by sliding the support limiter 506 over an overlapped length between the first and second support stoppers 502, 504. For example, as shown in FIG. 5, the support limiter 506 may be permanently engaged with the second support stopper 504 having the longer length. When the first and second support members 104, 106 are configured in the open configuration and are positioned farther away from each other, the support limiter 506 may be engaged only with the second support stopper 504 with which it is permanently engaged. The support limiter 506 may be configured to slide over the entire length of the second support stopper 504. In order to configure the first and second support members 104, 106 in the closed configuration, the first and second support members 104, 106 may be manually manipulated to be positioned closer to each other. When the first and second support members 104, 106 are configured in the closed configuration and therefore positioned close to each other, the support limiter 506 may be slid over the overlapped length between the first and second support stoppers 502, 504, to lock the first and second support members 104, 106 in the closed configuration. In order to release the closed configuration, the support limiter 506 may be slid in the opposite direction until the support limiter 506 fully releases the first support stopper 502. Once released from the closed configuration, the first and second support members 104, 106 may automatically move farther apart from each other under the effect of the second biasing member 814, to thereby configure the first and second support members 104, 106 in the open configuration.

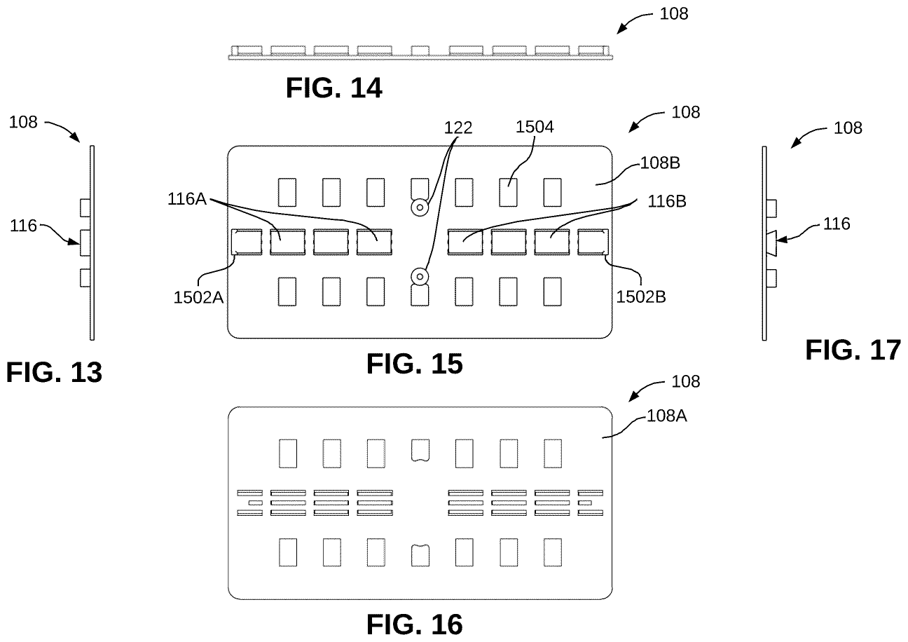

Referring once again to FIG. 2, 7, 8, the cleaning apparatus 100 may further include the cleaning plate 108 that may be configured to be attached to each of first and second support members 104, 106, via the distal ends 104B, 106B of the first and second support members 104, 106, respectively. In order to enable the cleaning plate 108 to be attached to the first and second support members 104, 106, the cleaning plate 108 may include a plurality of left tracks 116A and a plurality of right tracks 116B (the plurality of left tracks 116A and the plurality of right tracks 116B may also have been collectively referred to as tracks 116). The tracks 116 may be positioned along a longitudinal length of the cleaning plate 108 and on a rear side 108B of the cleaning plate 108. The construction of the cleaning plate 108 is further explained in conjunction with FIGS. 13-17.

Referring now to FIGS. 13-17, various views of the cleaning plate 108 are illustrated, in accordance with some embodiments. In particular, FIG. 13 illustrates a left-side view of the cleaning plate 108; FIG. 14 illustrates a top view of the cleaning plate 108; FIG. 15 illustrates a rear view of the cleaning plate 108; FIG. 16 illustrates a front view of the cleaning plate 108; and FIG. 17 illustrates a cross-sectional right-side view of the cleaning plate 108, in accordance with some embodiments. As mentioned above, the cleaning plate 108 is configured to be attached to each of first and second support members 104, 106, via the distal ends 104B, 106B of the first and second support members 104, 106, respectively.

The cleaning plate 108 may define a cleaning side (front side) 108A and an attachment side (rear side) 108B. As shown in FIGS. 15-16, the cleaning plate may include large, transversely oriented openings 1504 that may be parallel to the transverse side of the cleaning plate 108 and set along a longitudinal axis of the cleaning plate 108. These openings 1504 may facilitate the flexure of the cleaning plate 108, i.e. assist in flexibility. Further, one or more small, longitudinally oriented openings (parallel the longitudinal side of the cleaning plate 108) may be provided for the reason of shutoffs in the mold, that allow for a track to be manufactured during the manufacturing processes.

As can be seen in FIGS. 13-14, the tracks 116 may protrude out of a plane associated with the rear side 108B of the cleaning plate 108. Each of the tracks 116 may have a rectangular shape, as shown in FIG. 15. Further, length of each of the tracks 116 may be equal. Furthermore, the plurality of left tracks 116A may be equally spaced, and similarly, the plurality of right tracks 116B may be equally spaced. In an example embodiment, as shown in FIGS. 14-15, the cleaning plate 108 may include four left tracks 116A and four right tracks 116B. Further, as shown in FIG. 17, in some embodiments, each of the tracks 116 may define a taper along its top and bottom side.

As shown in FIGS. 2, 7, 8, the first support member 104 may include a first carriage 118A that may be rotatably coupled to the distal end 104B of the first support member 104. Further, the second support member 106 may include a second carriage 118B that may be rotatably coupled to the distal end 106B of the second support member 106. The first carriage 118A may be configured to engage with each of the plurality of left tracks 116A; and the second carriage 118B may be configured to engage with each of the plurality of right tracks 116B. As such, the cleaning plate 108 may be configured to be attached to the first and second support members 104, 106 by engaging one of the plurality of left tracks 116A with the first carriage 118A, and engaging one of the plurality of right tracks 116B with the second carriage 118B. It should be noted that length of each of the plurality of left tracks 116A and the plurality of right tracks 116B may be greater than length of the first carriage 118A and the second carriage 118B.

As such, the plurality of left and right tracks 116A, 116B may include discrete tracks, oriented longitudinally parallel to the longitudinal axis of the cleaning plate 108. A track-spacing between each discrete track may allow for the flexure of the cleaning plate 108. It should be noted that the size of the track-spacing between each pair of tracks may be smaller than a length of the first and second carriages 118A, 118B, to thereby enable the first and second carriages 118A, 118B to slide from one track to track. Further, the length of the tracks may be longer than the length of the first and second carriages 118A, 118B, to allow a smoother motion thereof from one track to the next.

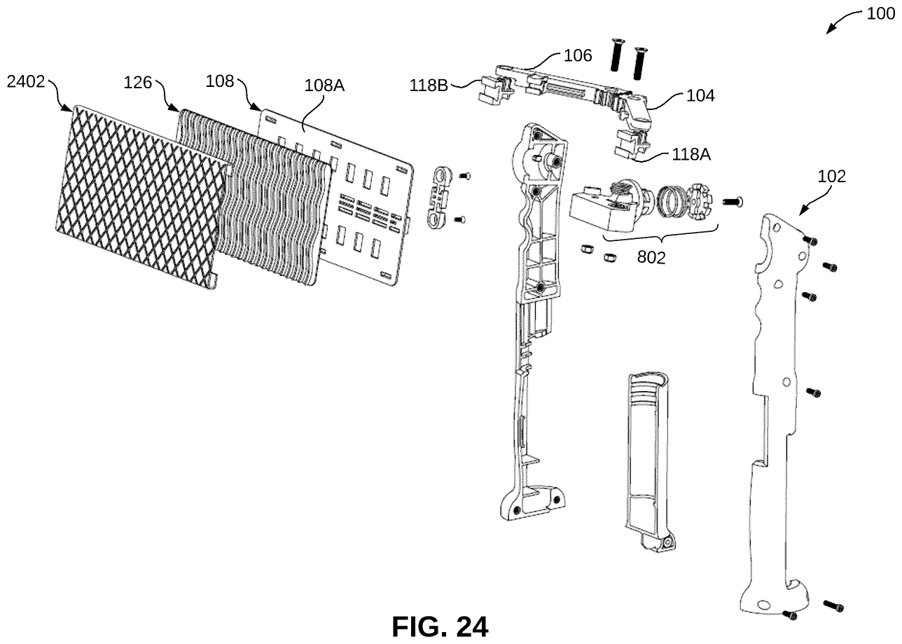

As shown in FIG. 1, the front side 108A (also referred to as cleaning side 108A) of the cleaning plate 108 may be configured to allow mounting of a gripping surface 126 126. The gripping surface 126, for example, may be manufactured from a rubber or rubber-like material. The gripping surface 126 may be configured to be attached (for example, bonded by an adhesive material) to the cleaning side 108A (front side) of the cleaning plate 108. The gripping surface 128 (also, referred to as “rubber grip” or “rubberized texture”) may be bonded to the cleaning side 108A of the cleaning plate 108 and may configured to receive a cleaning surface (as is shown in FIG. 24). The gripping surface 128 may be configured to increase friction between the cleaning side 108A of the cleaning plate 108 and the cleaning surface, thereby allowing for a rigorous scrubbing and achieving better cleaning results. As such, the cleaning surface remains secured to the cleaning plate 108 while experiencing various forces during cleaning.

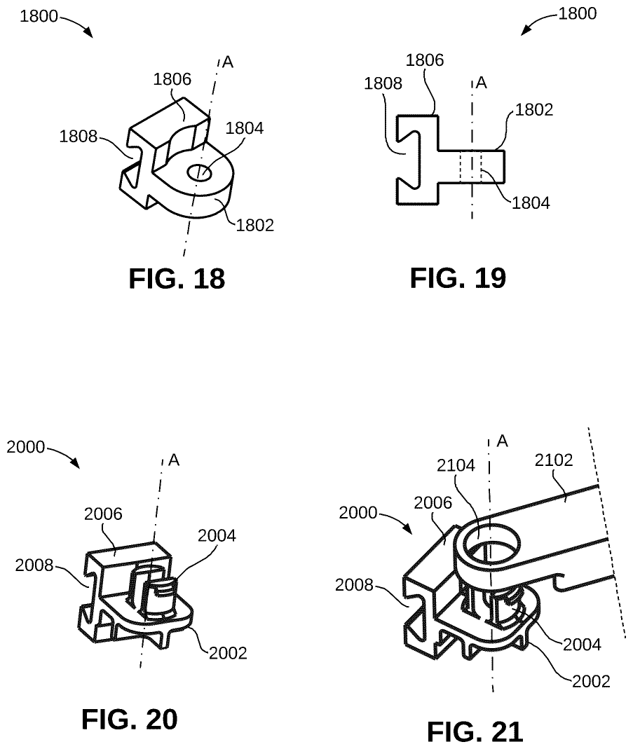

Referring now to FIGS. 18-19, a perspective view and a side view, respectively, of a carriage 1800 (representative of the first carriage 118A and the second carriage 118B) are illustrated, in accordance with some embodiments of the present disclosure. The carriage 1800 of FIGS. 18-19 corresponds to the embodiment shown in FIG. 8. The carriage 1800 may include a front portion 1806 and a rear portion 1802. The rear portion 1806 may be configured a flat horizontal plate and may include a hole 1804. The carriage 1800 may be configured to be rotatably coupled with the first support member 104 or the second support member 106, via the rear portion 1802. The coupling of the carriage 1800 with the first and support members 104, 106 may be achieved through any known-in-the-art coupling techniques, for example, a fastener/nut combination, a snap-fit assembly, interference (friction or press) fit assembly, etc. In particular, the carriage 1800 may be coupled with the first support member 104 or the second support member 106 by passing a pin or a bolt 802 (shown in FIG. 8), through the hole 1804. The first support member 104 and the second support member 106 may also include a hole similar to the hole 1804, at the distal ends 104B, 106B thereof. As such, the coupling created by passing the pin through the hole 1804 and the hole at the distal ends 104B, 106B may allow the carriage 1800 to rotate about the pin, and hence about an axis A (representative of the axis A2, A3 associated with the first and second support members 104, 106, respectively).

The front portion 1806 of the carriage 1800 may include a channel 1808 disposed opposite to the hole 1804. A back side of the front portion 1806 of the carriage 1800 may include a concave curve relief surface to accommodate a curve associated with distal ends 104B, 106B of the first and second support members 104, 106. The carriages may each include a connecting end that moveably links the carriage to respective distal end of the first and second support members. The carriages may further include a channel (i.e. track-engagement mechanism) that enables the carriage to slide along a track of the cleaning plate.

As can be seen in FIG. 19, the channel 1808 may include tapered walls along its top and bottom side. The channel 1808 may be configured to engage with the tracks 116 of the cleaning plate 108. In particular, the tapered walls of the channel 1808 may engage with the taper of the tracks 116. The taper of the tracks 116 may enable sliding of the carriage 1800 along the length of each of the tracks 116, and meanwhile, maintain the coupling between the tracks 116 and the carriage 1800. In other words, the taper of the tracks 116 and the tapered walls of the channel 1808 of the carriage 1800 may prevent falling off and decoupling of the carriage 1800 from the tracks 116.

FIG. 20 illustrates a perspective view of a carriage 2000 (representative of the first carriage 118A and the second carriage 118B), in accordance another embodiment of the present disclosure. Further, FIG. 21 illustrates a perspective view of the carriage 2000 (representative of the first carriage 118A and the second carriage 118B) engaged with a support member 2102 (representative of the first and second support members 104, 106), in accordance another embodiment of the present disclosure. The carriage 2000 of FIGS. 20-21 corresponds to the embodiment shown in FIG. 7.

The carriage 2000, similar to the carriage 1800, may include a front portion 2006 and a rear portion 2002. The rear portion 2002 may include a flat horizontal formation and a cylindrical clip 2004 formed thereon. The carriage 2000 may be configured to be rotatably coupled with the first support member 104 or the second support member 106, via the rear portion 2002. In particular, as shown in FIG. 21, the carriage 2000 may be coupled with the support member 2102 by passing the cylindrical clip 2004 of the carriage 2000 through a hole 2104 associated with the support member 2102. The support member 2102 may include the hole 2104 at a distal end thereof. The coupling created by passing the cylindrical clip 2004 through the hole 2104 at the distal end of the support member 2102 may allow the carriage 2000 to rotate about the cylindrical clip 2004, and hence about the axis A (representative of the axis A2, A3 associated with the first and second support members 104, 106, respectively). As can be seen in the FIG. 20, cylindrical clip 2004 may include a top protrusion that may prevent the support member 2102 to decouple from the cylindrical clip 2004 and hence from the carriage 2000, once the support member 2102 is engaged with the cylindrical clip 2004.

The front portion 2006 of the carriage 2000 may include a channel 2008 (similar the channel 1808). As can be seen in FIGS. 20-21, the channel 2008 may include tapered walls along its top and bottom side. The channel 2008 may be configured to engage with the tracks 116 of the cleaning plate 108. The taper of the tracks 116 may enable sliding of the carriage 2000 along the length of each of the tracks 116, meanwhile, maintaining the coupling between the tracks 116 and the carriage 2000. As such, the taper of the tracks 116 and the tapered walls of the channel 2008 of the carriage 2000 may prevent falling off and decoupling of the carriage 2000 from the tracks 116.

In some embodiments, as shown in FIGS. 2, 7, 8, the cleaning plate 108 may further include a proximal carriage barrier 120 that may be positioned in the middle of the longitudinal length of cleaning plate 108. The proximal carriage barrier 120 may be configured to provide a stopping point for the first carriage 118A and the second carriage 118B, when the first and second support members 104, 106 are in the closed configuration. As such, a longitudinal width of the proximal carriage barrier 120 may be dimensioned based on the minimum possible distance between the distal ends 104B, 106B of the first and second support members 104, 106, in the closed configuration. In some embodiments, as shown in FIG. 7, 8, the proximal carriage barrier 120 may be detachable from the cleaning plate 108. To this end, as shown in FIGS. 7, 8, 15, the cleaning plate 108 may include ports 122 that may allow attaching of the proximal carriage barrier 120 to the cleaning plate 108. For example, the ports 122 may include holes, such that the proximal carriage barrier 120 can be attached to the cleaning plate 108 using fasteners 124 (as shown in FIGS. 7, 8) via the holes. The fasteners 124, for example, may include a screw, a nut-bolt assembly, a rivet, etc.

In some embodiments, the cleaning plate 108 may further include a left distal carriage barrier 1502A positioned towards the left extreme end of the longitudinal length of cleaning plate 108, and a right distal carriage barrier 1502B positioned towards the right extreme end of the longitudinal length of cleaning plate 108. In particular, the left distal carriage barrier 1502A may be implemented in a left-most track of the plurality of left tracks 116A, and the right distal carriage barrier 1502B may be implemented in a right-most track of the plurality of right tracks 116B. The left distal carriage barrier 1502A and the right distal carriage barrier 1502B may be configured to provide a stopping point for the first carriage 118A and the second carriage 118B, respectively, when the first and second support members 104, 106 are in the open configuration. For example, the left distal carriage barrier 1502A may include a protruded formation on left-end of the left-most track of the plurality of left tracks 116A. Similarly, the right distal carriage barrier 1502B may include a protruded formation on right-end of the right-most track of the plurality of right tracks 116B.

As mentioned above, the tracks 116 enable sliding of the carriages 118A, 118B along the length of each of the tracks 116. However, the protruded formation may create an obstruction in the sliding movement of the carriages 118A, 118B, thereby preventing subsequent sliding movement of the carriages 118A, 118B. Therefore, the protruded formation on the left-end of the left-most track of the plurality of left tracks 116A may obstruct the sliding movement of the first carriage 118A beyond that point, thereby preventing the first carriage 118A from falling outside the track. Similarly, the protruded formation on the right-end of the right-most track of the plurality of right tracks 116B may obstruct the sliding movement of the second carriage 118B beyond that point, thereby preventing the second carriage 118B from falling outside the track.

In some embodiments, the handle 102 may include a housing for receiving a cartridge containing a cleaning solution, such that the cartridge may be configured to be operated for spraying a dosage of cleaning solution for assisting in cleaning action to be performed using the cleaning plate. With reference to FIG. 7, the handle 102 may include a top module 702 and a bottom module 704. The top module 702 may be detachably attached to the bottom module 704. Further, the bottom module 704 may define a housing for receiving a cartridge 710. Further, as can be seen in FIG. 7, the top module 702 may be coupled to the cleaning plate 108, via the connector 110.

In particular, as shown in FIG. 7, the top module 702 may include a left half 702A and a right half 702B, such that the left half 702A and the right half 702B are configured to be fastened together to form the top module 702. For example, the left half 702A and the right half 702B may be fastened using one or more fasteners 720. The fasteners 720 may be selected from screws, nut-bolt assemblies, rivets, etc.

The bottom module 704 may be cylindrical in shape and include a hollow section 716 that may define the housing in which the cartridge 710 may be placed. The bottom module 704 may further define a base 718 that may provide a platform for placing the cartridge 710.

As shown in FIG. 7, the cartridge 710 may include a container 712 in which the cleaning solution may be stored. Further, the cartridge 710 may include a spray module 714 coupled to the container 712. The spray module 714 may be manipulated by a user to dispense (i.e. spray) a dosage of the cleaning solution from the container 712. To this end, the spray module 714 may include a spray hole and a conduit (not shown in FIG. 7) connecting to the container. When operated by the user, the spray module 714 may draw a dosage of the cleaning solution from the container via the conduit, and dispense the dosage via the spray hole.

In order to accommodate the spray module 714 of the cartridge 710, the bottom module 704 may include cut-outs 708A, 708B disposed opposite to each other. As such, the cut-outs 708A, 708B may accommodate the protruding sections of the spray module 714.

As mentioned above, the top module 702 may be detachably attached to the bottom module 704. To this end, bottom module 704 may include a pair of snap buttons 706A, 706B, and the top module 702 may include a pair of slots 722A (only slot 722 is visible in FIG. 7). The snap buttons 706A, 706B may include bumps that may engage with the slots 722A of the top module 702 to thereby attach the top module 702 with the bottom module 704. In order to detach the bottom module 704 from the top module 702, for example, for replacing the cartridge 710, the snap buttons 706A, 706B may be pushed inwards using the fingers of the hands of the user; this releases the slots 722A of the top module 702 to thereby allow detaching of the top module 702 from the bottom module 704.

In some alternate embodiments, as shown in FIG. 8, the handle 102 may be implemented differently as compared to the one illustrated in FIG. 7. Referring to FIG. 8, the handle 102 may include a housing for receiving a cartridge containing a cleaning solution, such that the cartridge is configured to be operated for spraying a dosage of cleaning solution for assisting in cleaning action to be performed using the cleaning plate. The handle 102 may include a body which may be implemented in a first half 816 and a second half 818. The first half 816 and the second half 818 may be configured to be fastened together using a plurality of fasteners 820. For example, the fasteners 820 may include screws, nut-bolt assemblies, rivets, etc. Other methods of fastening together the first half 816 and the second half 818 may include ultrasonic welding, or any other known assembly methods.

The body of the handle 102 may include a top section that may be constituted by a first top section 816A of the first half 816 and a second top section 818A of the second half 818. Further, the body of the handle 102 may include a bottom section constituted by a first bottom section 816B of the first half 816 and a second bottom section 818B of the second half 818. The top section (816A, 818A) of the handle 102 may be coupled to the cleaning plate 108 via the connector 110, as shown in FIG. 8.

In some embodiments, the top section (816A, 818A) may include a first ergonomic grip portion. The bottom section (816B, 818B) may include a second ergonomic grip portion adapted for placement of gripping fingers of the user. The inner side of the first top section 816A and the second top section 818A may include stiffening structures that improve the structural integrity of the handle 102.

The bottom section (816B, 818B) of the handle 102 may define a housing 832 in which the cartridge (not shown in FIG. 8, however, similar to the cartridge 710 of FIG. 7) containing the cleaning solution may be positioned. The bottom section (816B, 818B) may further include a pivotable door 822, that may provide for securing the cartridge once the cartridge is placed in the housing 832. The pivotable door 822 may be pivotably coupled with the first bottom section 816B and the second bottom section 818B. To this end, the pivotable door 822 may include a projection 826 that may further define a hole 828 through which the pivot may be established. Further, the first bottom section 816B and the second bottom section 818B may include holes 824A and 824B respectively through which the pivot may be established. For example, a common fastener 830 may be passed through the hole 824A, the hole 828, and the hole 824B, to thereby pivotably couple the pivotable door 822 with the first bottom section 816B and the second bottom section 818B.

In order to access the housing 832 for removing or replacing the cartridge from the housing 832, the pivotable door 822 may be rotated about the pivot downwards, to expose the housing 832. Once the cartridge is replaced in the housing 832, the pivotable door 822 may be rotated about the pivot upwards, to thereby secure the cartridge within the housing 832. As such, the pivotable door 822 may have an internal configuration that is commensurate with the configuration of the cartridge, and may include a base near a lower end of the pivotable door 822 for resting a bottom portion of the container within the pivotable door 822.

In some embodiments, a locking mechanism may be provided to lock the pivotable door 822 after it is rotated upwards. For example, the pivotable door 822 may include lateral protuberances at the upper distal end, such that when the door is in a closed position, the lateral protuberances mate with corresponding lateral indentations of the handle.

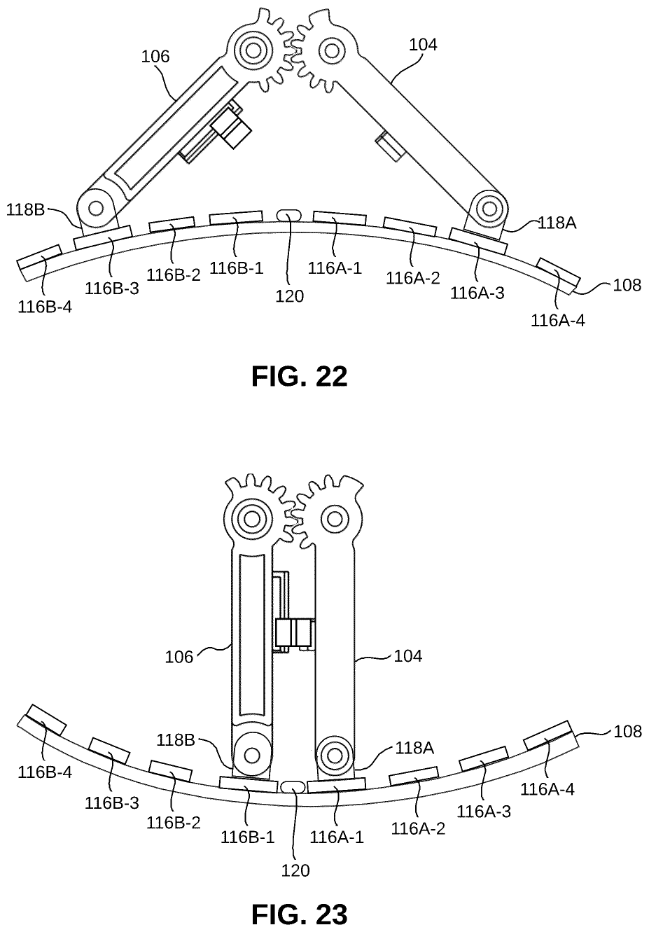

In some embodiments, the cleaning plate 108 may possess out-of-plane flexibility that may enable the cleaning plate 108 to be configured in a convex curvature and a concave curvature. This is because the cleaning plate 108 may be manufactured from a material having sufficient degree of flexibility. For example, the cleaning plate 108 may be manufactured from plastic, or an alloy such as Steel. The out-of-plane flexibility allows the cleaning plate 108 to assume different curvatures that may allow the cleaning plate 108 to perform the cleaning operation more effectively. This is further explained in detail in conjunction with FIGS. 22-23.

Referring now to FIG. 22, a schematic top view 2200 of a part of the cleaning apparatus 100 showing the first and second support members 104, 106, the first and second carriages 118A, 118B, and the cleaning plate 108 configured in concave curvature is illustrated, in accordance with some embodiments. As shown in FIG. 22, the cleaning plate 108 includes four left tracks 116A-1, 116A-2, 116A-3, and 116A-4 (collectively also referred to as left tracks 116A), and four right tracks 116B-1, 116B-2, 116B-3, and 116B-4 (collectively also referred to as right tracks 116B). Further, the cleaning plate 108 includes the proximal carriage barrier 120 positioned in the middle of the longitudinal length of cleaning plate 108.

The first support member 104 may include the first carriage 118A that may be rotatably coupled to the distal end 104B of the first support member 104. Further, the second support member 106 may include the second carriage 118B that may be rotatably coupled to the distal end 106B of the second support member 106. The first carriage 118A may be configured to engage with each of the plurality of left tracks 116A; and the second carriage 118B may be configured to engage with each of the plurality of right tracks 116B. As such, the cleaning plate 108 may be configured to be attached to the first and second support members 104, 106 by engaging one of the plurality of left tracks 116A with the first carriage 118A, and engaging one of the plurality of right tracks 116B with the second carriage 118B.

Therefore, when the first and the second carriages 118A, 118B are engaged with tracks 116 positioned away from the middle of the cleaning plate 108, and as such, the distance between the distal ends 104B, 106B of the first and second support members 104, 106 is greater than a predefined distance, the cleaning plate 108 may be configured in the concave curvature. The predefined distance may depend on the degree of flexibility of the material of the cleaning plate 108. As shown in FIG. 22, when the when the first carriage 118A is engaged with left track 116A-3 (third track from the middle amongst the left tracks 116A), and the second carriage 118B is engaged with right track 116B-3 (third track from the middle amongst the right tracks 116B), the cleaning plate 108 may be able to assume the concave curvature. As will be understood, even when the first carriage 118A is engaged with left track 116A-4 (fourth track from the middle amongst the left tracks 116A), and the second carriage 118B is engaged with right track 116B-4 (fourth track from the middle amongst the right tracks 116B), the cleaning plate 108 may still be able to assume the concave curvature. The concave curvature may be desirable when cleaning is supposed to be performed over outer surfaces of round or cylindrical objects

Referring now to FIG. 23, a schematic top view 2300 of a part of the cleaning apparatus 100 showing the first and second support members 104, 106, the first and second carriages 118A, 118B, and the cleaning plate 108 configured in convex curvature is illustrated, in accordance with some embodiments. As shown in FIG. 23, the cleaning plate 108 includes four left tracks 116A-1, 116A-2, 116A-3, and 116A-4 (collectively also referred to as left tracks 116A), and four right tracks 116B-1, 116B-2, 116B-3, and 116B-4 (collectively also referred to as right tracks 116B). Further, the cleaning plate 108 includes the proximal carriage barrier 120 positioned in the middle of the longitudinal length of cleaning plate 108. The proximal carriage barrier 120 may be configured to provide a stopping point for the first carriage 118A and the second carriage 118B, when the first and second support members 104, 106 are in the closed configuration.

When the first and the second carriages 118A, 118B are engaged with tracks 116 positioned closer to the middle of the cleaning plate 108 (i.e. closer to the proximal carriage barrier 120), and as such, the distance between the distal ends 104B, 106B of the first and second support members 104, 106 is lesser than the predefined distance, the cleaning plate 108 may be configured in the convex curvature. The predefined distance may depend on the degree of flexibility of the material of the cleaning plate 108. As shown in FIG. 23, when the first carriage 118A is engaged with left track 116A-1 (first track from the middle amongst the left tracks 116A), and the second carriage 118B is engaged with right track 116B-1 (first track from the middle amongst the right tracks 116B), the cleaning plate 108 may be able to assume the convex curvature. The concave curvature may be desirable when cleaning is supposed to be performed on inner surfaces of round or cylindrical objects.

Referring now to FIG. 24, another exploded view of the cleaning apparatus 100, corresponding to the cleaning apparatus 100 shown in FIG. 8, is illustrated in accordance with some embodiments. The cleaning apparatus 100 includes the handle 102, the first and second support members 104, 106, the cleaning plate 108, the first and second carriages 118A, 118B among other components. As shown in FIG. 24, the front side 108A (also referred to as cleaning side 108A) of the cleaning plate 108 may be configured to allow mounting of the gripping surface 126. The gripping surface 126 may be configured to be attached to the cleaning side 108A of the cleaning plate 108, for example, by way of bonding using an adhesive material. The gripping surface 128 may be configured to receive a cleaning surface 2402. For example, the cleaning surface 2402 may include a disposable or microfiber bonnet type cleaning cloth (and hence the cleaning surface 2402 may also be referred to as cleaning cloth). The cleaning surface 2402 may be detachably attached to the front side 108A of the cleaning plate 108 over the gripping surface 126 by any of known connection mechanisms, including VELCRO®. Further, the front side 108A may include holding mechanism, such as hooks to allow for attachment of the cleaning surface 2402 to the cleaning plate 108. The gripping surface 128 may increase friction between the cleaning side 108A of the cleaning plate 108 and the cleaning surface 2402, thereby allowing for rigorous scrubbing and achieving better cleaning results. As such, the cleaning surface 2402 remains secured to the cleaning plate 108 while experiencing various forces during cleaning.

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. Further, in the foregoing description, numerous details are set forth to further describe and explain one or more embodiments. These details include system configurations and accompanying written description. While these details are helpful to explain one or more embodiments of the disclosure, those skilled in the art will understand that these specific details are not required in order to practice the embodiments.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A cleaning apparatus comprising:
a handle defining a top end and a bottom end;
a first and a second support member, each defining a proximal end and a distal end, and each of the first and the second support members being coupled with the handle near the top end of the handle, via a connector,
wherein the connector is rotatably coupled with the handle and is configured to rotate relative to the handle about a horizontal axis, and
wherein each of first and the second support members is rotatably coupled with the connector via the respective proximal end, and is configured to rotate about a respective vertical axis perpendicular to the horizontal axis, as a result of which, a distance between the distal ends of the first and the second support members is variable; and
a cleaning plate configured to be attached to each of first and the second support members, via the distal ends of the first and the second support members.

2. The cleaning apparatus of claim 1, wherein each of first and the second support members comprises a plurality of gear teeth, wherein the plurality of gear teeth of the first support member are meshed with the plurality of gear teeth of the second support member, as a result of which, rotation of one of the first and second support member causes an equal and opposite rotation of the other of the first and second support member.

3. The cleaning apparatus of claim 1 further comprising a locking mechanism for locking the rotation of the connector relative to the handle about the horizontal axis.

4. The cleaning apparatus of claim 3, wherein the locking mechanism comprises:
one of a female locking structure and a male locking structure associated with the connector; and
the other of the female locking structure and the male locking structure associated with the handle,
wherein the connector is configured to move linearly towards the handle to engage the female locking structure and male locking structure, to thereby lock the rotation of the connector relative to the handle, and
wherein the connector is further configured to move linearly away from the handle to disengage the female locking structure and male locking structure, to thereby unlock and enable the rotation of the connector relative to the handle.

5. The cleaning apparatus of claim 4, wherein the locking mechanism further comprises:
a first biasing member attached to the connector and positioned between the female locking structure and the male locking structure, to bias the connector towards the handle to thereby keep the female locking structure and the male locking structure engaged with each other and thereby lock the rotation of the connector relative to the handle,
wherein the connector is to move linearly away from the handle upon overcoming a biasing force of the first biasing member.

6. The cleaning apparatus of claim 1 further comprising:
a second biasing member engaged with one of the first and the second support members on one end thereof and with the connector on another end thereof, wherein the second biasing member is to bias the first and the second support members in one of a closed configuration and open configuration,
wherein, in the closed configuration, the distance between the distal ends of the first and the second support members is a minimum possible distance, and
wherein, in the open configuration, the distance between the distal ends of the first and the second support members is a maximum possible distance.

7. The cleaning apparatus of claim 1, wherein the first and the second support members comprises a first support stopper and a second support stopper, respectively, on inner side thereof, wherein each of the first and the second support stopper has a sliding profile,
wherein the cleaning apparatus further comprises a support limiter configured to slidably engage with the first and the second support stopper,
wherein, when engaged with both the first and the second support stopper, the support limiter is to lock the first and the second support members in the closed configuration.

8. The cleaning apparatus of claim 7, wherein one of the first support stopper and the second support stopper is of a longer length than the other of the first support stopper and the second support stopper, wherein the support limiter is permanently engaged with one of the first support stopper and the second support stopper having the longer length, and is engaged with the other of the first support stopper and the second support stopper when the first and the second support members are in the closed configuration, by sliding the support limiter over an overlapped length between the first and the second support stopper.

9. The cleaning apparatus of claim 8, wherein one of the first support stopper and the second support stopper having the longer length comprises end-barriers to arrest the falling-off of the support limiter.

10. The cleaning apparatus of claim 1, wherein the cleaning plate possesses out-of-plane flexibility enabling the cleaning plate to be configured in a convex curvature and a concave curvature,
wherein the cleaning plate is configured in the concave curvature when the distance between the distal ends of the first and the second support members is more than a minimum predefined distance,
wherein the cleaning plate is configured in the convex curvature when the distance between the distal ends of the first and the second support members is less than the minimum predefined distance.

11. The cleaning apparatus of claim 1,
wherein the cleaning plate comprises: a plurality of left tracks and a plurality of right tracks positioned along a longitudinal length of the cleaning plate and on a rear side of the cleaning plate,
wherein the first support member comprises a first carriage rotatably coupled to the distal end of the first support member, and the second support member comprises a second carriage rotatably coupled to the distal end of the second support member, and
wherein the cleaning plate is configured to be attached to the first and second support members by engaging one of the plurality of left tracks with the first carriage and engaging one of the plurality of right tracks with the second carriage.

12. The cleaning apparatus of claim 11, wherein length of each of the plurality of left tracks and a plurality of right tracks is greater than length of the first carriage and the second carriage.

13. The cleaning apparatus of claim 11, wherein the cleaning plate comprises:
a proximal carriage barrier positioned in the middle of the longitudinal length of cleaning plate, wherein the proximal carriage barrier is configured to provide a stopping point for the first carriage and the second carriage, when the first and the second support members are in the closed configuration.

14. The cleaning apparatus of claim 11, wherein the cleaning plate further comprises:
a left distal carriage barrier positioned towards the left extreme end of the longitudinal length of cleaning plate, and a right distal carriage barrier positioned towards the right extreme end of the longitudinal length of cleaning plate,
wherein the left distal carriage barrier and the right distal carriage barrier are configured to provide a stopping point for the first carriage and the second carriage, respectively, when the first and the second support members are in the open configuration.

15. The cleaning apparatus of claim 1, wherein the handle comprises a housing for receiving a cartridge containing a cleaning solution, wherein the cartridge is configured to be operated for sparing a dosage of cleaning solution for assisting in cleaning action to be performed using the cleaning plate.

16. The cleaning apparatus of claim 15, wherein the handle comprises a top module and a bottom module, wherein the top module is detachably attached to the bottom module, wherein the bottom module defines the housing for receiving the cartridge, and wherein the top module is coupled to the cleaning plate.

17. A cleaning apparatus comprising:
a handle defining a top end and a bottom end;
a first and a second support member, each defining a proximal end and a distal end, and each of the first and the second support members being coupled with the handle near the top end of the handle, via a connector,
wherein the connector is adjustably coupled with the handle and is configured to be adjusted relative to the handle, and
wherein each of first and the second support members is adjustably coupled with the connector via the respective proximal end, and is configured to adjust, as a result of which, a distance between the distal ends of the first and the second support members is variable; and
a cleaning plate configured to be attached to each of first and the second support members, via the distal ends of the first and the second support members.
